(19) United States
(12) Patent Application Publication
(10) Pub. No.: US 2024/0348740 A1
(43) Pub. Date: Oct. 17, 2024

(54) SCALABLE RATIONAL COLOR CORRECTION FOR AN IMAGE

(71) Applicant: HUAWEI TECHNOLOGIES CO., LTD., Shenzhen (CN)

(72) Inventors: Konstantin Vitalyevich Soshin, Moscow (RU); Dmitry Petrovich NIKOLAEV, Moscow (RU); Egor Ivanovich Ershov, Moscow (RU); Mikhail Konstantinovich TCHOBANOU, Moscow (RU)

(21) Appl. No.: 18/750,729

(22) Filed: Jun. 21, 2024

Related U.S. Application Data
(63) Continuation of application No. PCT/RU2021/000591, filed on Dec. 23, 2021.

(51) Int. Cl. H04N 1/60; G06T 7/90

(52) U.S. Cl. CPC H04N 1/6008; G06T 7/90; G06T 2207/10024

(57) ABSTRACT

The present disclosure relates to image processing, and specifically to color correction of an image. The color correction includes a color space transformation of the image. To this end, the disclosure provides a device and a corresponding method for transforming an image from a source color space to a target color space. The device comprising a processor configured to, for each pixel of the image, obtain channel response values of the pixel, and calculate three or more rational values based on the channel response values of the pixel. The processor is further configured to transform the image from the source color space into the target color space using the three or more rational values calculated for each of the pixels.

### CROSS-REFERENCE TO RELATED APPLICATIONS

This application is a continuation of International Application No. PCT/RU2021/000591, filed on Dec. 23, 2021, the disclosure of which is hereby incorporated by reference in its entirety.

### TECHNICAL FIELD

The present disclosure relates to image processing, and specifically to color correction of an image. The color correction includes a color space transformation of the image. To this end, the disclosure provides a device and a corresponding method for transforming an image from a source color space to a target color space.

### BACKGROUND

One of the mandatory steps in a digital image capture pipeline is the conversion of an image, captured with a sensor, from the sensor color space to a suitable observer color space. For example, the standard observer CIE XYZ color space may be used. Herein, Y is the luminance, Z is quasi-equal to blue (of CIE RGB), and X is a mixture of the three CIE RGB curves chosen to be non-negative. For simplicity, this color space is referred to as XYZ color space in this disclosure. Such a color space conversion of an image is also known as color space transform or color correction.

This disclosure targets improvements to such color space conversions. In particular, to color space transformations of images between arbitrary color spaces, where an exact transformation is unknown.

### SUMMARY

The present disclosure and its solutions are further based on the following considerations of the inventors.

It may be assumed that an incident radiation with a spectrum Φ(λ) is captured, in a particular point, by a sensor having three or more color channels. For example, the color channels may include red, green and blue (RGB), and the channels may have respective spectral sensitivities, for example, r(λ) for red, g(λ) for green and b(λ) for blue. This is illustrated exemplarily in FIG. 1, wherein response functions for the above-mentioned color channels are shown in a diagram with the wavelength plotted on the x-axis (in nm), and the sensitivity plotted on the y-axis.

The three response functions can also be combined in a vector-function JJ_{RGB}=(r(λ), g(λ), b(λ))^{T} for simplicity. The sensor response \vec{c}_{RGB}=(R, G, B)^{T} can then be obtained based on the vector-function as follows:

$${\vec{c}}_{R G B} = {( R , G , B )}^{T} = {\int }_{{ω}_{v i s}} Φ ( λ ) {\vec{χ}}_{R G B} ( λ ) d λ$$

In the above formula, ωᵥᵢₛ is, for example, a range of 380-780 nm, i.e., may be a visible spectral range (notably, diapasones may change from standard to standard, and/or from sensor to sensor). The above model of the sensor is called linear. It is important to note that the color channel responses are device-dependent, however, it may be convenient to map them to a device-independent color space, such as the XYZ color space. Such a device-independent color space is more useful for measurement and further processing.

The standard observer's response can be obtained in the same way as above—but by instead using the XYZ matching functions x(λ), y(λ) and z(λ) (as shown in FIG. 2, again with the wavelength plotted on the x-axis and the sensitivity plotted on the y-axis), which may again be combined in a vector-function \vec{X}xvz(λ)=(x(λ), y(λ), z(λ))^{T}—as follows:

$${\vec{c}}_{X Y Z} = {( X , Y , Z )}^{T} = {\int }_{{ω}_{v i s}} Φ ( λ ) {\vec{χ}}_{X Y Z} ( λ ) d λ$$

Finding an accurate transformation \vec{c}_{RGB}→\vec{c}_{XYZ} is challenging. Further, as mentioned before, a device-independent color space is more useful for measurement and unification of further processing of the captured image in the imaging pipeline, since this may allow simultaneously considering sensitivity differences between sensors made by different manufacturers, and/or differences in sensor instances of the same model.

It is important to note that the accuracy of the solution is crucial for large-scale device production. That is, because large errors at this stage can lead to an unpredictable behavior of a significant part of the produced batch of devices.

From a machine learning perspective, finding the correct transformation between a source color space and a target color space may be treated as a regression task. For example, there may be a set of training data: the responses {\vec{c}_{RGB}^{l}}ₗ₌₁^{m} of the sensor in its own color space, and the corresponding XYZ-values {\vec{c}_{RGB}^{l}}ₗ₌₁^{m} (ground-truth), wherein m is the number of color patches in the training data, and wherein 1≤l≤m.

The simplest approach is a linear regression. Given the set of {\vec{c}_{RGB}^{l}}ₗ₌₁^{m} of RGB values and the corresponding set of XYZ values {\vec{c}_{RGB}^{l}}ₗ₌₁^{m}, a 3×3 transformation matrix T can be found as follows:

$${T}_{L C C} = arg {min}_{T} {\sum }_{l = 1}^{m} {‖ T {\vec{c}}_{R G B}^{l} - {\vec{c}}_{X Y Z}^{l} ‖}_{2}^{2}$$

This approach is called linear color correction (LCC) in this disclosure. Although it produces significant errors, it works correctly when the scene radiance or the exposure changes, and it is easy to compute.

A basic idea for improving this LCC is to extend the default RGB values using additional terms. For example, using polynomial features as additional terms. The extension of the RGB values is understood as an increase in the number of features. In machine learning this technique is referred to as polynomial regression, and is thus called polynomial color correction (PCC) in this disclosure. For example, the following takes features of a degree up to 2:

$$\vec{ρ} = {ϕ}_{P C C} ( {\vec{c}}_{R G B} ) = {( R , G , B , {R}^{2} , {G}^{2} , {B}^{2} , RG , RB , GB )}^{T}$$

The regression task can be solved over these new polynomial features:

$${T}_{P C C} = arg {min}_{T} {\sum }_{l = 1}^{m} {‖ T {\vec{ρ}}^{l} - {\vec{c}}_{X Y Z}^{l} ‖}_{2}^{2}$$

In the above formula, T_{PCC} is a matrix 3×n, wherein n≥3 is the number of features. Extending the feature space helps to reduce mapping errors. However, it works incorrectly when the scene radiance or exposure changes. For example, for a certain camera exposure a surface in the scene may be represented by the RGB vector \vec{c}_{RGB}, which may be mapped to the XYZ vector \vec{c}_{XYZ}.

It would be expected that any color correction algorithm maps k\vec{c}_{RGB} to k\vec{c}_{XYZ} as well in this case, wherein k denotes a scaling factor of the surface radiance. However, PCC is not invariant to changes of camera exposure, since it has non-linear terms, whereas LCC has this property.

In an exemplary approach, a regression may be used with a weighted geometric mean (may also be referred to as root polynomial color correction (RPCC) in this disclosure. An idea in this case is to extract the root of each polynomial term, wherein the root is of such a degree that as a result all members have the first degree. Such terms scale with exposure time value. The following is for features of the degree up to 2:

$$\vec{r} = {\vec{ϕ}}_{R P C C} ( \vec{{c}_{RGB}} ) = {( R , G , B , \sqrt{R G} , \sqrt{R B} , \sqrt{B G} )}^{T}$$

The transformation matrix can be found as:

$${T}_{R P C C} = arg {min}_{T} {\sum }_{l = 1}^{m} {‖ T \vec{{r}^{l}} - \vec{{c}_{X Y Z}^{l}} ‖}_{2}^{2}$$

In the sense of exposure invariance, RPCC works correctly and reduces mapping errors. However, in practice, when calculating the additional terms, one is faced with a time consuming procedure for extracting roots of different degrees. This can be a problem when the algorithm works on a mobile device. Most arithmetic operations can be efficiently vectorized on modern processors, but root extraction is still computationally expensive.

In view of the above, this disclosure has the objective to provide a better solution for a color space transformation of an image. For instance, an objective is to improve the accuracy of the color space transformation. Further, an objective is to avoid computationally expensive operations, such as a root extraction, when increasing the number of features. Accordingly, another objective is to provide a fast solution. Another objective is to achieve an enhanced performance for low light scenarios. Still another objective is to make the solution exposure invariant.

These and other objectives are achieved by the solutions described in the independent claims. Advantageous implementations are further defined in the dependent claims.

A first aspect of this disclosure provides a device for a color space transformation of an image, the device comprising a processor configured to, for each pixel of a plurality of pixels of the image: obtain channel response values of the pixel, the channel response values comprising a first channel response value, a second channel response value, and a third channel response value of the pixel; and calculate three or more rational values based on the channel response values of the pixel; wherein the processor is further configured to: transform the image from a source color space, which is defined by the channel response values of the pixels of the image, into a target color space using the three or more rational values calculated for each of the pixels.

According to the first aspect, the original channel response values—of, for instance, a sensor used for capturing the image—are extended by the rational terms. This may be referred to as increasing the number of features. That is, the original channel response values and the extended rational terms may, respectively, be called features. The extension helps to reduce mapping errors during the color space conversion, and accordingly leads to an improved, more accurate image in the target color space. Since the additional terms/features are not polynomials in this case, but are rational terms, a root extraction is not required. Also other computationally expensive operations can be avoided, and thus the solution is fast and of low complexity. The solution also works well in low light scenarios.

In an implementation form of the first aspect, the channel response values of the pixel are RGB values of the pixel, the RGB values consisting of a red value (R) being the first channel response value of the pixel, a green value (G) being the second channel response value of the pixel, and a blue value (B) being the third channel response value of the pixel.

For instance, many commercial sensors are based on the RGB color space, which is typically sensor-specific, that is, device-dependent. The RGB values can be extended in this case by additional terms/features. The color space conversion can be into a device-independent color space in this case, for example, into the XYZ color space.

In an implementation form of the first aspect, the processor is configured to: generate a channel response vector for each pixel, the channel response vector comprising the channel response values of the pixel and further comprising the three or more rational values calculated for the pixel; and transform the image from the first color space into the second color space using the channel response vectors calculated for each of the pixels.

Thus, a vector-function as described above may be applied to the proposed solution.

In an implementation form of the first aspect, the processor is configured to calculate each rational value by using a respective rational term on the channel response values of the pixel, wherein each rational term is linear in that scaling the channel response values of the pixel by a scaling factor k>0 scales the rational value calculated by using the rational term on the scaled channel response values of the pixel by the same scaling factor k.

This scaling behavior makes the solution exposure invariant, for instance, in case of scene exposure changes or radiance changes.

In an implementation form of the first aspect, each rational term is a rational function f(R, G, B), wherein f(k*R, k*G, k*B)=k*f(R, G, B).

Such a rational function leads to accurate results for the color space transformation, and also to an invariance on the exposure.

In an implementation form of the first aspect, each rational term has a numerator and a denominator, wherein the numerator is an n-degree monomial based on the channel response values of the pixel, and wherein the denominator is an n-1 degree homogeneous polynomial based on the channel response values of the pixel, wherein n is an integer and n≥1.

Such rational terms to calculate the rational values lead to particularly accurate results of the color space transformation, while being of low computational complexity.

In an implementation form of the first aspect, for n=2 the processor is configured to calculate three rational values by respectively using the following three rational terms on the RGB values of the pixel:

$$R \times G / ( R + G + B ) ;$$

$$R \times B / ( R + G + B ) ;$$

$$G \times B / ( R + G + B ) .$$

This example for n=2 (degree of 2) leads to accurate results. Notably “x” denotes a multiplication in this disclosure.

In an implementation form of the first aspect, for n=3 the processor is configured to calculate seven rational values by respectively using the following seven rational terms on the RGB values of the pixel:

$$R \times G / ( R + G + B ) ;$$

$$R \times B / ( R + G + B ) ;$$

$$G \times B / ( R + G + B ) ;$$

$$R \times {G}^{2} / {( R + G + B )}^{2} ;$$

$$R \times G \times B / {( R + G + B )}^{2} ;$$

$$R \times {B}^{2} / {( R + G + B )}^{2} ;$$

$$G \times {B}^{2} / {( R + G + B )}^{2} .$$

This example for n=3 (degree of 3) leads to accurate results.

In an implementation form of the first aspect, the processor is configured to calculate the three or more rational values by respectively using the rational terms of the following set F of rational terms on the RGB values of the pixel:

$${F}_{n} = \{ \frac{{R}^{{α}_{1}} \cdot {G}^{{α}_{2}} \cdot {B}^{{α}_{3}}}{{( R + G + B )}^{{α}_{1} + {α}_{2} + {α}_{3} - 1}} , 1 \leq {α}_{1} + {α}_{2} + {α}_{3} \leq n , n , {α}_{1} , {α}_{2} , {α}_{3} ∈ ℕ \}$$

This solution may be applied generally, that is, for any degree n.

In an implementation form of the first aspect, the processor is further configured to: determine a transformation matrix based on the three or more rational values calculated for each of the pixels; and transform the image from the source color space into the target color space using the transformation matrix.

Once the transformation matrix is found, it may be stored and used at need. More than one image may be converted from the source color space into the target color space based on the transformation matrix. Thus, an efficient solution is provided.

In an implementation form of the first aspect, the transformation matrix is determined by performing a Moore-Penrose pseudo-inverse operation based on the generated channel response vectors.

This allows obtaining the transformation matrix in an efficient and accurate manner. Besides the pseudo-inverse operation, the transformation matrix may also be found for a different metric and by using a special minimization method (for example, gradient based, or any other suitably method).

In an implementation form of the first aspect, the source color space is a device-dependent color space, and the target color space is a device-independent color space.

As mentioned above, the transformation into the device-independent color space is beneficial for further processing.

In an implementation form of the first aspect, the target color space is defined by XYZ values of the pixels of the image, each XYZ value consisting of a first tristimulus value, X, a second tristimulus value, Y, and a third tristimulus value Z of a pixel.

Thus, the CIE XYZ color space may be selected as the target color space in the solutions of this disclosure.

In an implementation form of the first aspect, the processor is further configured to store the transformed image or information indicative of the transformed image in the device.

This may help converting a next image, for example, faster or with improved accuracy. The color space conversion of the next image may take into account the stored information or transformed image.

In an implementation form of the first aspect, the processor is configured to calculate the three or more rational values for each pixel based further on a parameter used to limit the first channel response value, the second channel response value, and/or the third channel response value of the channel response values of the pixel to a minimum value.

This is beneficial, especially for low light scenarios, as the implementation clips (limits) pixels with small intensities to avoid division by very small numbers. For example, the parameter may be 10⁻³ or lower.

In an implementation form of the first aspect, the processor is configured to calculate the three or more rational values for each pixel based further on one or more weighting parameters used to weigh the first channel response value, the second channel response value, and/or the third channel response value of the channel response values of the pixel.

This allows a flexible adaption of the calculation of the rational values.

A second aspect of this disclosure provides method for a color space transformation of an image, the method comprising, for each pixel of a plurality of pixels of the image: obtaining channel response values of the pixel, the channel response values comprising a first channel response value, a second channel response value, and a third channel response value of the pixel; and calculating three or more rational values based on the channel response values of the pixel; and the method further comprising transforming the image from a source color space, which is defined by the channel response values of the pixels of the image, into a target color space using the three or more rational values calculated for each of the pixels.

In an implementation form of the second aspect, the channel response values of the pixel are RGB values of the pixel, the RGB values consisting of a red value (R) being the first channel response value of the pixel, a green value (G) being the second channel response value of the pixel, and a blue value (B) being the third channel response value of the pixel.

In an implementation form of the second aspect, the method comprises: generating a channel response vector for each pixel, the channel response vector comprising the channel response values of the pixel and further comprising the three or more rational values calculated for the pixel; and transforming the image from the first color space into the second color space using the channel response vectors calculated for each of the pixels.

In an implementation form of the second aspect, the method comprises calculating each rational value by using a respective rational term on the channel response values of the pixel, wherein each rational term is linear in that scaling the channel response values of the pixel by a scaling factor k>0 scales the rational value calculated by using the rational term on the scaled channel response values of the pixel by the same scaling factor k.

In an implementation form of the second aspect, each rational term is a rational function f(R, G, B), wherein f(k*R, k*G, k*B)=k*f(R, G, B).

In an implementation form of the second aspect, each rational term has a numerator and a denominator, wherein the numerator is an n-degree monomial based on the channel response values of the pixel, and wherein the denominator is an n-1 degree homogeneous polynomial based on the channel response values of the pixel, wherein n is an integer and n≥1.

In an implementation form of the second aspect, for n=2 the method comprises calculating three rational values by respectively using the following three rational terms on the RGB values of the pixel:

$$R \times G / ( R + G + B ) ;$$

$$R \times B / ( R + G + B ) ;$$

$$G \times B / ( R + G + B ) .$$

In an implementation form of the second aspect, for n=3 the method comprises calculating seven rational values by respectively using the following seven rational terms on the RGB values of the pixel:

$$R \times G / ( R + G + B ) ;$$

$$R \times B / ( R + G + B ) ;$$

$$G \times B / ( R + G + B ) ;$$

$$R \times {G}^{2} / {( R + G + B )}^{2} ;$$

$$R \times G \times B / {( R + G + B )}^{2} ;$$

$$R \times {B}^{2} / {( R + G + B )}^{2} ;$$

$$G \times {B}^{2} / {( R + G + B )}^{2} .$$

In an implementation form of the second aspect, the method comprises calculating the three or more rational values by respectively using the rational terms of the following set F of rational terms on the RGB values of the pixel:

$${F}_{n} = \{ \frac{{R}^{{α}_{1}} \cdot {G}^{{α}_{2}} \cdot {B}^{{α}_{3}}}{{( R + G + B )}^{{α}_{1} + {α}_{2} + {α}_{3} - 1}} , 1 \leq {α}_{1} + {α}_{2} + {α}_{3} \leq n , n , {α}_{1} , {α}_{2} , {α}_{3} ∈ ℕ \}$$

In an implementation form of the second aspect, the method comprises: determining a transformation matrix based on the three or more rational values calculated for each of the pixels; and transforming the image from the source color space into the target color space using the transformation matrix.

In an implementation form of the second aspect, the transformation matrix is determined by performing a Moore-Penrose pseudo-inverse operation based on the generated channel response vectors.

In an implementation form of the second aspect, the source color space is a device-dependent color space, and the target color space is a device-independent color space.

In an implementation form of the second aspect, the target color space is defined by XYZ values of the pixels of the image, each XYZ value consisting of a first tristimulus value, X, a second tristimulus value, Y, and a third tristimulus value Z of a pixel.

In an implementation form of the second aspect, the method further comprises storing the transformed image or information indicative of the transformed image in the device.

In an implementation form of the second aspect, the method comprises calculating the three or more rational values for each pixel based further on a parameter used to limit the first channel response value, the second channel response value, and/or the third channel response value of the channel response values of the pixel to a minimum value.

In an implementation form of the second aspect, the method comprises calculating the three or more rational values for each pixel based further on one or more weighting parameters used to weigh the first channel response value, the second channel response value, and/or the third channel response value of the channel response values of the pixel.

The method of the second aspect and its implementation forms achieve the same advantages and effects as described above for the device of the first aspect and its respective implementation forms.

A third aspect of this disclosure provides a computer program comprising instructions which, when the program is executed by a processor, cause the processor to perform the method according the second aspect or any implementation form thereof.

A fourth aspect of the present disclosure provides a non-transitory storage medium storing executable program code which, when executed by a processor, causes the method according to the second aspect or any of its implementation forms to be performed.

This disclosure accordingly proposes a technique to extend the channel response values of an obtained image, for instance, color components like red, green, blue (RGB) values (also referred to as “features”), by using rational functions at each pixel of the image. This enables a more accurate transformation (in the sense of a given color difference metric) from a device-dependent color space (e.g., from RGB color space) to a device-independent color space (e.g., to XYZ color space). The extension of the original channel response values is understood as an increase in the number of features involved in the calculation of the correct color space transformation. For example, not just three channel response values can be used in the red, green and blue channels RGB, but also polynomials of the second degree R², G², B², RG, RB, GB (as described later, this way to extend the original channel response values is called PCC).

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 shows spectral sensitivities r(λ), g(λ), and b(λ) of an exemplary sensor.

FIG. 2 shows CIE standard observer's matching functions x(λ), y(λ), z(λ).

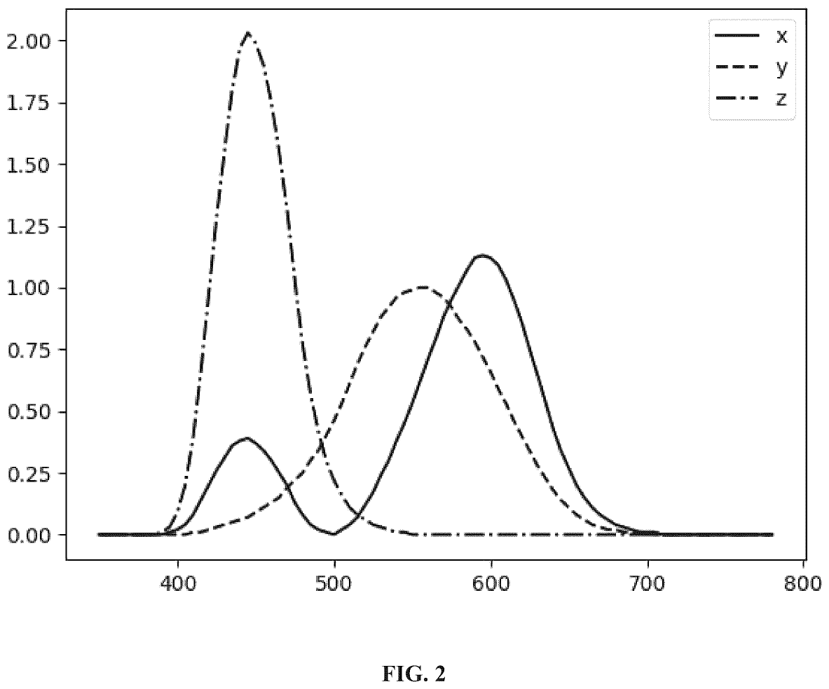

FIG. 3 shows a device for a color space transformation of an image, according to an embodiment of this disclosure.

FIG. 4 shows Table 1, which includes synthetic data simulation results.

FIG. 5 shows Table 2, which includes values indicating a computational complexity.

FIG. 6 shows a first aspect or part of a method for color space transformation of an image, according to an embodiment of this disclosure.

FIG. 7 shows a second aspect or part of a method for color space transformation of an image, according to an embodiment of this disclosure.

FIG. 8 shows a method for color space transformation, according to an embodiment of this disclosure.

### DETAILED DESCRIPTION OF EMBODIMENTS

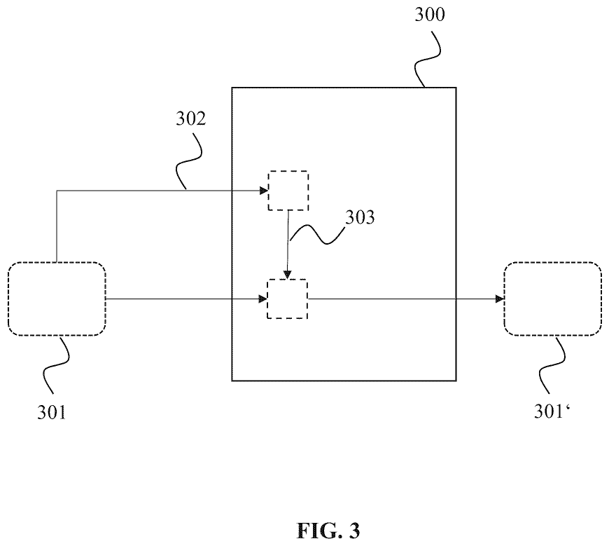

FIG. 3 shows a device 300 according to an embodiment of the invention. The device 300 is configured to perform a color space transformation (can also be called color space conversion) of an image 301. The image 301 may be captured by a sensor. For instance, the device 300 may be part of an image pipeline of a camera including the sensor, or may be an image processing device for post-processing one or more sensor images. The device 300 may also be a camera, which may include the sensor configured to capture the image 301 and accordingly output channel response values per image pixel. The image 301 comprises a plurality of pixels. The image 301 may also be a frame of a video, or one of many images of an image sequence.

The device 300 comprises a processor (not illustrated explicitly in FIG. 3, but may comprise two processing instances as indicated by the dashed boxes). The processor may also be referred to as processing circuitry. The processor is configured to, for each pixel of the image 301, to obtain channel response values 302 of the pixel. The channel response values 302 may be produced and obtained from a sensor. The channel response values 302 comprise a first channel response value, a second channel response value, and a third channel response value of the pixel. For instance, the channel response values 302 of the pixel may comprise or consist of RGB values of the pixel. For example, the first channel response value of the pixel may be R (red), the second channel response value of the pixel may be G (green), and the third channel response value of the pixel may be B (blue).

The processor of the device 300 is further configured to calculate, for each pixel of the image 301, three or more rational values 303 based on the channel response values 302 of the pixel. For example, the processor may be configured to calculate each rational value 303 by using a respective rational term on the channel response values 302 of the pixel. Each rational term may be linear, and/or may be a rational function. For example, the rational terms may be linear having the characteristic that, if the channel response values 302 of the pixel are scaled by a scaling factor k>0, also the rational value 303 scales by the same scaling factor k.

The processor is further configured to transform/convert the image 301 from a source color space into a target color space. For example, the processor may obtain a transformed image 301′ in the target color space. The device 300 may output the transformed image 301′. The processor is configured to use the three or more rational values 303 calculated for each pixel of the image 301 in the color space transformation of the image 301 into the transformed image 301′. That is, the processor transforms the image 301 based on an increased number of features compared to without the additional rational values 303.

The source color space may be defined by the channel response values 302 of the pixels of the image 301, for instance, it may be defined by RGB values of the pixel. The target color space may be defined by XYZ values of the pixels of the image 301. Each XYZ value may comprise or consist of a first tristimulus value X, a second tristimulus value Y, and a third tristimulus value Z of the pixel. Notably, the source color space may a device-dependent or sensor-dependent color space, while the target color space may a device-independent or sensor-independent color space.

The processor of the device 300 is accordingly configured to perform, conduct, or initiate various operations of the device 300 as described in this disclosure. The processor may comprise hardware and/or may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors.

The device 300 may further comprise memory circuitry, which may be configured to store one or more instruction(s), which can be executed by the processor, for instance, under the control of the software. For instance, the memory circuitry may comprise a non-transitory storage medium, which may store executable software code that, when executed by the processor, causes the various operations of the device 300 described in this disclosure to be performed.

In one exemplar embodiment, the processor comprises one or more processing cores and a non-transitory memory connected to the one or more processing cores. The non-transitory memory may carry executable program code, which, when executed by the one or more processing cores, causes the device 300 to perform, conduct, or initiate the operations or methods described in this disclosure.

The processor of the device 300 may be further configured to generate a channel response vector for each pixel of the image 301. The channel response vector may comprise the channel response values 302 of the pixel, and may further comprise the three or more rational values 303 calculated by the processor for that pixel. The device 300 may in this case transform the image 301 from the first color space to the second color space using the channel response vectors, which are calculated by the processor for each of the pixels.

For instance, this disclosure 300 proposes to extend a channel response vector of RGB values using scalable rational terms to calculate the rational values 303. For a channel response vector \vec{c}_{RGB}=(R, G, B)^{T} a scalable rational color correction (SRCC) may be considered. The set of scalable rational terms of the degree n may have the following form:

$${F}_{n} = \{ \frac{{R}^{{α}_{1}} {G}^{{α}_{2}} {B}^{{α}_{3}}}{{( R + G + B )}^{{α}_{1} + {α}_{2} + {α}_{3} - 1}} , 1 \leq {α}_{1} + {α}_{2} + {α}_{3} \leq n \}$$

where 0≤α₁, 0≤α₂, 0≤α₃ ∈N, n≤1. Alternatively, a multi-index notation may be used:

$${F}_{k} = \{ \frac{{\vec{c}}_{R G B}^{α}}{{( R + G + B )}^{\vert α \vert - 1}} , 1 \leq \vert α \vert \leq n \}$$

where α=(α₁, α₂, α₃) is multi-index such that \vec{c}_{RGB}^{α}=R^{a}^{₁}G^{a}^{₂}B^{a}^{₃} and |α|=α₁+α₂+α₃. In other words, the rational terms may each comprise a denominator with a degree that is one less than the numerator degree. Note that correction |α|=1 is the same as the LCC. Each rational term may accordingly have a numerator and a denominator, wherein the numerator may be an n-degree monomial based on the channel response values 302 of the pixel, and wherein the denominator may be an n-1 degree homogeneous polynomial based on the channel response values 302 of the pixel, wherein n is an integer and n≥1.

In practice (for example, for low light scenarios) it may convenient to introduce a small parameter, e.g. ∈˜10⁻³ or less, to clip (limit) pixels with small intensities to avoid division by very small number. In this case, the above formula may become:

$${F}_{n} = \{ \frac{{\vec{c}}_{RGB}^{α}}{{( max \{ R + G + B , ϵ \} )}^{\vert α \vert - 1}} , 1 \leq \vert α \vert \leq n \}$$

Accordingly, the processor of the device 300 may be configured to calculate the three or more rational values 303 for each pixel based further on the parameter ∈, which is used to limit the first channel response value, the second channel response value, and/or the third channel response value of the channel response values 302 of the pixel to a minimum value, respectively.

Moreover, the proposed model can be further generalized by introducing additional parameters τᵣ, τ_{g}, τ_{b}, such that the above formula becomes:

$${F}_{n} = \{ \frac{{\vec{c}}_{RGB}^{α}}{{( max \{ {τ}_{r} R + {τ}_{g} G + {τ}_{b} B , ϵ \} )}^{\vert α \vert - 1}} , 1 \leq \vert α \vert \leq n \} ,$$

$$\vert {τ}_{r} \vert + \vert {τ}_{r} \vert + \vert {τ}_{r} \vert > 0$$

Accordingly, the processor of the device 300 may be configured to calculate the three or more rational values 303 for each pixel based further on one or more weighting parameters τᵣ, τ_{g}, τ_{b}, which are used to weigh the first channel response value, the second channel response value, and/or the third channel response value of the channel response values 302 of the pixel.

In the following, only the first formula described above is considered, for reasons of simplicity. However, the further description could also be based on any of the two other formulas including the parameter e and/or the weighting parameters τᵣ, τ_{g}, τ_{b}.

It may be noted that the set Fₙ may consist of linearly dependent rational terms. For example, if n=2:

$${F}_{2} = \{ R , G , B , \frac{{R}^{2}}{R + G + B} , \frac{{G}^{2}}{R + G + B} , \frac{{B}^{2}}{R + G + B} , \frac{RG}{R + G + B} , \frac{RB}{R + G + B} , \frac{BG}{R + G + B} \} .$$

It can be seen in this case that:

$$R = \frac{R ( R + G + B )}{R + G + B} = \frac{{R}^{2}}{R + G + B} + \frac{RG}{R + G + B} + \frac{RB}{R + G + B} ,$$

which means that:

$$R , \frac{{R}^{2}}{R + G + B} , \frac{RG}{R + G + B} , \frac{RB}{R + G + B}$$

are linearly dependent. This can lead to the so-called multi-collinearity issue and to overfitting. If, however, some terms are excluded from Fₙ in such a way that the remaining terms are linearly independent, the set \tilde{F}ₙ of linearly independent scalable rational terms may be obtained. These rational terms may be used to calculate the rational values 303.

Below are given lists of such independent terms of the degree up to n=3:

$$\tilde{{F}_{1}} = \{ R , G , B \}$$

$$= \{ R , G , B , \frac{RG}{R + G + B} , \frac{RB}{R + G + B} , \frac{BG}{R + G + B} \}$$

$$= \{ R , G , B , \frac{RG}{R + G + B} , \frac{RB}{R + G + B} , \frac{BG}{R + G + B} , \frac{{RG}^{2}}{{( R + G + B )}^{2}} , \frac{RGB}{{( R + G + B )}^{2}} , \frac{{RB}^{2}}{{( R + G + B )}^{2}} , \frac{{GB}^{2}}{{( R + G + B )}^{2}} \}$$

SRCC can be formulated as a regression over these scalable rational features the same way as in RPCC. For instance, if an example for the features of the degree n=2 is considered:

$$\vec{f} = {ϕ}_{SRCC} ( {\vec{c}}_{RGB} ) = {( R , G , B , \frac{RG}{R + G + B} , \frac{RB}{R + G + B} , \frac{BG}{R + G + B} )}^{T}$$

$${T}_{SRCC} = arg {min}_{T} {\sum }_{l = 1}^{m} E ( T \vec{{f}^{l}} , {\vec{c}}_{XYZ}^{l} )$$

where E is an error function, usually measured by a [symbol] ₂ metric.

The transformation matrix T (of size 3×n, where n≥3—is the number of features) may be found in different ways. For example, a training dataset—for which as an example the features R, G and B as well as X,Y and Z are calculated—can be defined, wherein the transformation matrix T can then be estimated on this training set. A [symbol] ₂ metric based minimization approach may be to find the transformation matrix T by performing a pseudo-inverse matrix calculation. Also other optimization techniques, e.g., using a color difference criteria (including perceptual ones) and metrics [symbol] ₚ, 1≤p≤∞, may be applied to find the transformation matrix T.

To sum up the above, the proposed solution of this disclosure has the following properties:
Enhanced performance for scene exposure or radiance changes: It can be seen that the correction with the above-escribed rational values 303 may be linear in the sense of multiplying by a scalar (scaling factor λ). That is, when multiplying the channel exposure values 302 (e.g., R, G, and B channels of the vector \vec{c}_{RGB}) by the factor k, the features will be multiplied by the same factor k, which means that the algorithm works correctly when scene exposure or radiance changes. In other words, the algorithm has the same property, as RPCC, but—as it is shown below—is less computationally expensive.
Enhanced performance for low light scenario: The possibility to introduce a small parameter e allows avoiding division by very low values (e.g. R+G+B), and thus enables dealing with low light scenario. This is a very important case in color computational photography. Scalable rational features show also a higher level of stability for low-light scenarios, due to their mathematical properties. Particularly, derivative calculation of root-polynomial features (for RPCC) may lead to negative powers, which may be unstable when channel response values 302, like RGB values, are close to zero. At the same time, scalable rational features do not have such a disadvantage. This is an important property, because feature stability is crucial for color correction methods.

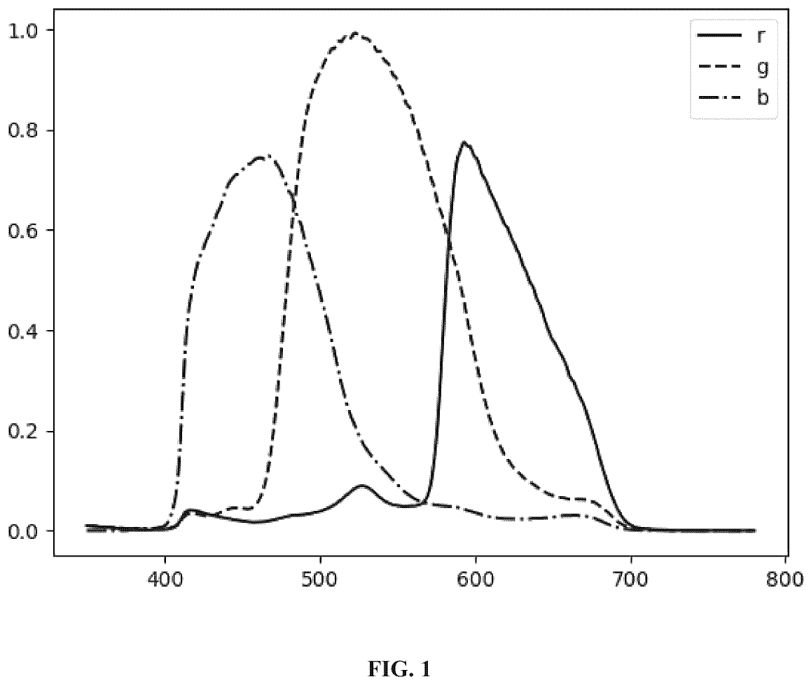

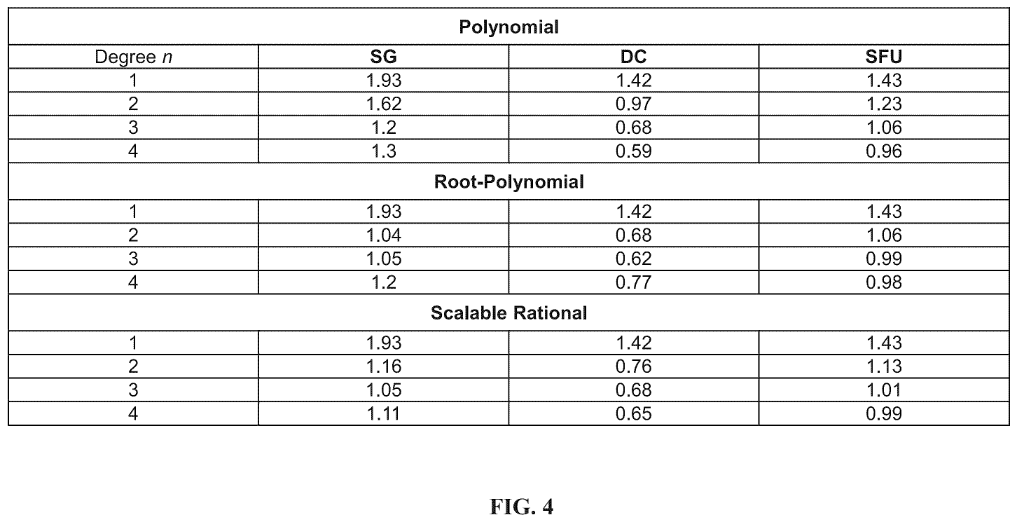

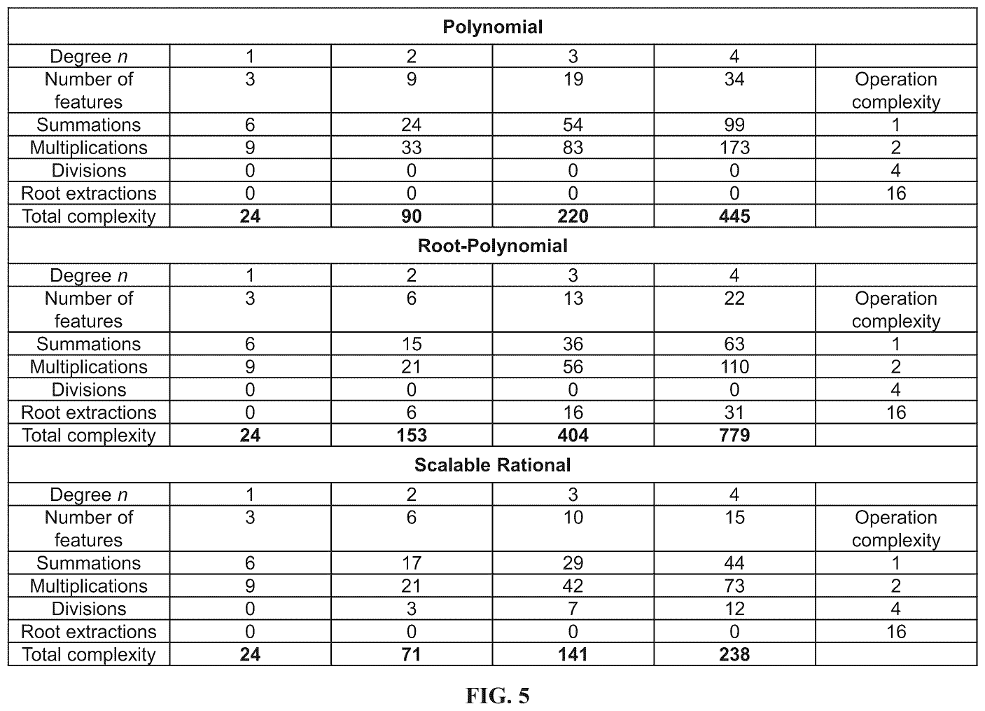

Synthetic tests of correction models on color charts (ColorChecker DC, ColorChecker SG, and SFU dataset) were carried out for the exemplary camera shown in FIG. 1 (main camera of a Huawei Mate 20 Pro mobile phone) under D65 illuminant. The model of the present disclosure was evaluated using the leave-one-out validation method using the CIEDE2000 color difference formula (the smaller the value, the better). The leave-one-out procedure refers to the special case of a cross-validation technique, wherein in order to find the optimal transformation, one uses all but one of the samples from a training set and test model on the remaining patch, i.e. calculate CIEDE2000 metrics. This procedure is repeated for all samples in the dataset and the mean metric is calculated. The results are presented in Table 1 (see FIG. 4). The computational complexity comparison provided in Table 2 (see FIG. 5).

As can be seen from Table 1, the accuracy of the scalable rational solution of this disclosure is higher than the polynomial solution and comparable to the root-polynomial solution. However, as shown in Table 2, the scalable rational solution of this disclosure is about 3 times faster than the root-polynomial solution.

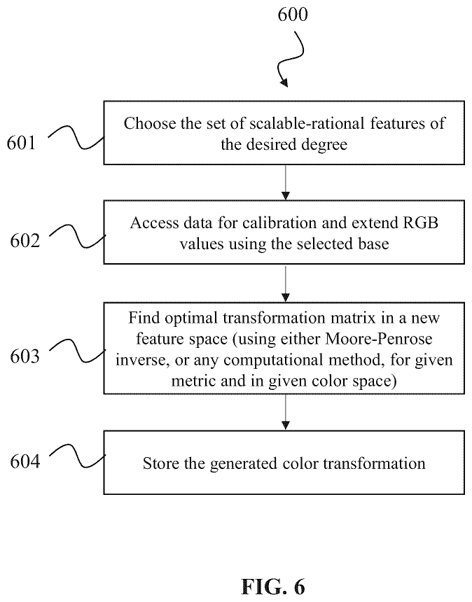

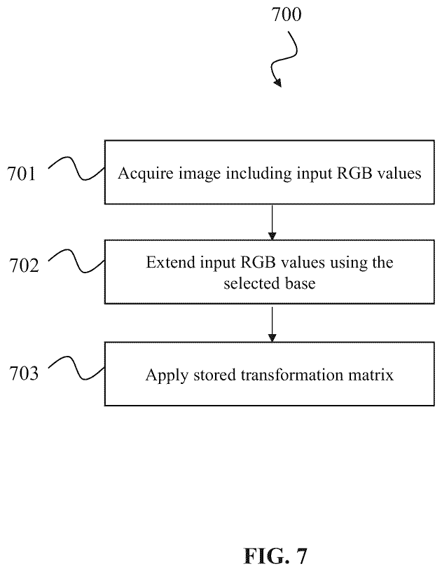

The use of the solution of this disclosure, in a final product like a camera, may comprise two parts of a procedure. First, the proper transformation matrix T_{SRCC} is found for a particular camera having a sensor with spectral sensitivities \vec{X}_{RGB}(λ). This first part 600 of the procedure is exemplarily illustrated in the block diagram of FIG. 6. The first part 600 may be performed only once. The second part 700 of the procedure is an application stage, which may be applied for each response of the camera sensor during shooting throughout the life of the camera. This second part 700 is shown in the block diagram of FIG. 7. Below, both parts 600 and 700 are described in detail.

To find the proper transformation matrix T_{SRCC}, the degree n of the features is chosen first in step 601. On the one hand, by increasing the number of parameters, the accuracy of the solution may be increased. However, this may also lead to both an increase in calculations and overfitting. Thus, there can be a trade-off in the choice of the degree of the features. As it can be seen in the simulation results, the degree n=3 gives usually a satisfactory result.

The proper transformation matrix may be found from the data, in which each sensor response \vec{c}_{RGB} corresponds to a known XYZ values \vec{c}_{XYZ}. This data can be both synthetic, i.e., with rendered spectra under a specific lighting, and can be the real responses of the sensor on objects with known XYZ values, for example, on patches of a color target.

Then, for sensor response from the training dataset {\vec{c}_{RGB}^{l}}ₗ₌₁^{m}, new features can be calculated using in step 602 the selected base:

$${\vec{f}}^{i} = {ϕ}_{SRCC} ( {\vec{c}}_{RGB}^{i} ) ∀ i ∈ 1 , … , k$$

Note that RGB values may be normalized using information about light sources' colors and/or by a scalar. If so, the same normalization procedure may be used for the first step of application stage.

Then, the correct transformation matrix can be found in step 603 as the solution of minimization problem:

$${\sum }_{l = 1}^{m} {‖ T \vec{{f}^{l}} - \vec{{c}_{XYZ}^{l}} ‖}_{2}^{2} \to {min}_{T}$$

Usually, there is a matrix R such that j-th column equals to \vec{f^{j}} and matrix Q such that j-th column of Q equals to \vec{c}_{XYZ}^{j}. Using a Moore-Penrose pseudo-inverse operation, the solution of a minimization problem may be found:

$${T}_{SRCC} = {{QR}^{T} ( {RR}^{T} )}^{- 1}$$

This gives an exact solution, however, other techniques are also possible, such as a gradient-descent method (e.g., applied in a different color space and using a different metric [symbol] ₚ, 1≤p≤∞).

In step 604, the generated color transformation, in particular, the transformation matrix can be stored in the device 300.

Having calculated the transformation matrix T_{SRCC} once, this transformation matrix may then be used to process the channel responses from the sensor/camera, as shown in FIG. 7. For instance, in step 701 an input image with RGB values {\vec{c}_{RGB}^{l}}ₗ₌₁^{m} may be received. In step 702 these RGB values may be extended using the rational base {\vec{c_{RGB}^{l}}}ₗ₌₁^{m}→{\vec{f}^{l}}₁₌₁^{m}. Then the color space transformation may be performed in step 703 by using the stored transformation matrix (matrix multiplication):

$${T}_{SRCC} {\vec{f}}^{j} = {\vec{y}}^{j} \approx {\vec{c}}_{XYZ}^{j}$$

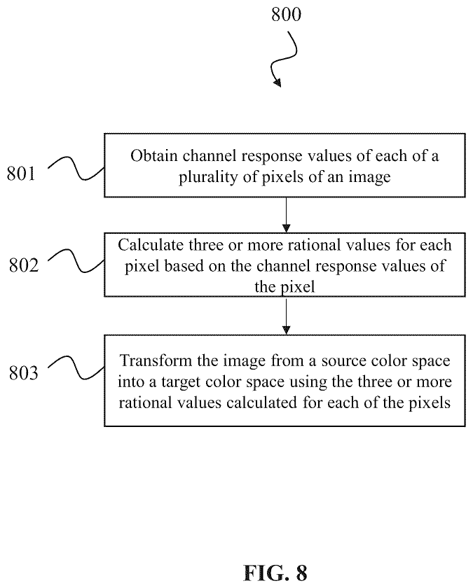

FIG. 8 shows a general method 800, according to an embodiment of this disclosure, which the device 300 may perform.

The method 800 comprises a step 801 of obtaining channel response values 302 of the pixel. The channel response values 302 comprise a first channel response value, a second channel response value, and a third channel response value of the pixel. For example, as in step 701 of FIG. 7, the channel response values 302 of the pixel may be RGB values of the pixel, with the first channel response value of the pixel being R, the second channel response value of the pixel being G, and the third channel response value of the pixel being B.

The method 800 further comprises a step 802 of calculating three or more rational values 303 based on the channel response values 302 of the pixel. For example, as in step 702 of FIG. 7, RGB values of the pixel may be extended using a rational base.

The method 800 further comprises a step 803 of transforming the image 301 from a source color space, which is defined by the channel response values 302 of the pixels of the image, into a target color space using the three or more rational values 303 calculated for each of the pixels. For example, as in step 703 of FIG. 7, the image 301 may be transformed from the source color space into the target color space using the transformation matrix.

The solutions of this disclosure provide the following benefits:
The accuracy of the solution of this disclosure (scalable rational) is higher than the polynomial solution and comparable to the root-polynomial solution.
The solution of this disclosure does not require computationally expensive operations such as root extractions, and thus works faster.
The solution of this disclosure works exposure invariant, i.e., a correction with the rational values 303 is linear in sense of multiplying by a scalar. This means that the algorithm works correctly also when the scene exposure or the radiance changes. In other words, it has the same property, as the RPCC, but is far less computationally expensive.
The solution of this disclosure shows an enhanced performance for low light scenarios, which is a very important case in color computational photography. On the one hand, this may be achieved by the possibility to introduce the small parameter e. On the other hand, the solution shows a higher level of stability for low light scenarios also due to its mathematical properties. Particularly, derivative calculation of root-polynomial features (for RPCC) may lead to negative powers, which may be unstable when RGB values are close to zero. At the same time, the rational features/values 303 do not have such disadvantage. This is an important property because feature stability is crucial for color correction methods.

The present disclosure has been described in conjunction with various embodiments as examples as well as implementations. However, other variations can be understood and effected by those persons skilled in the art and practicing the claimed subject matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A device (300) for a color-space transformation of an image (301), the device (300) comprising a processor configured to, for each pixel of a plurality of pixels of the image (301):
obtain channel response values (302) of the pixel, the channel response values (302) comprising a first channel response value, a second channel response value, and a third channel response value of the pixel; and
calculate three or more rational values (303) based on the channel response values (302) of the pixel;
wherein the processor is further configured to:
transform the image (301) from a source color space, which is defined by the channel response values (302) of the pixels of the image (301), into a target color space using the three or more rational values (303) calculated for each of the pixels.

2. The device (300) according to claim 1, wherein the channel response values (302) of the pixel are RGB values of the pixel, the RGB values consisting of a red value, R, being the first channel response value of the pixel, a green value, G, being the second channel response value of the pixel, and a blue value, B, being the third channel response value of the pixel.

3. The device (300) according to claim 1, wherein the processor is configured to:
generate a channel response vector for each pixel, the channel response vector comprising the channel response values (302) of the pixel and further comprising the three or more rational values (303) calculated for the pixel; and
transform the image (301) from the first color space into the second color space using the channel response vectors calculated for each of the pixels.

4. The device (300) according to claim 1, wherein the processor is configured to calculate each rational value (303) by using a respective rational term on the channel response values (302) of the pixel, wherein each rational term is linear in that scaling the channel response values (302) of the pixel by a scaling factor k>0 scales the rational value (303) calculated by using the rational term on the scaled channel response values (302) of the pixel by the same scaling factor k.

5. The device (300) according to claim 4,
wherein the channel response values (302) of the pixel are RGB values of the pixel, the RGB values consisting of a red value, R, being the first channel response value of the pixel, a green value, G, being the second channel response value of the pixel, and a blue value, B, being the third channel response value of the pixel, and
wherein each rational term is a rational function f(R, G, B), wherein f(k*R, k*G, k*B)=k*f(R, G, B).

6. The device (300) according to claim 4, wherein each rational term has a numerator and a denominator, wherein the numerator is an n-degree monomial based on the channel response values (302) of the pixel, and wherein the denominator is an n-1 degree homogeneous polynomial based on the channel response values (302) of the pixel, wherein n is an integer and n≥1.

7. The device (300) according to claim 6,
wherein the channel response values (302) of the pixel are RGB values of the pixel, the RGB values consisting of a red value, R, being the first channel response value of the pixel, a green value, G, being the second channel response value of the pixel, and a blue value, B, being the third channel response value of the pixel, and
wherein for n=2 the processor is configured to calculate three rational values (303) by respectively using the following three rational terms on the RGB values of the pixel:
$$R \times G / ( R + G + B ) ;$$
$$R \times B / ( R + G + B ) ;$$
$$G \times B / ( R + G + B ) .$$

8. The device (300) according to claim 6,
wherein the channel response values (302) of the pixel are RGB values of the pixel, the RGB values consisting of a red value, R, being the first channel response value of the pixel, a green value, G, being the second channel response value of the pixel, and a blue value, B, being the third channel response value of the pixel, and
wherein for n=3 the processor is configured to calculate seven rational values (303) by respectively using the following seven rational terms on the RGB values of the pixel:
$$R \times G / ( R + G + B ) ;$$
$$R \times B / ( R + G + B ) ;$$
$$G \times B / ( R + G + B ) ;$$
$$R \times {G}^{2} / {( R + G + B )}^{2} ;$$
$$R \times G \times B / {( R + G + B )}^{2} ;$$
$$R \times {B}^{2} / {( R + G + B )}^{2} ;$$
$$G \times {B}^{2} / {( R + G + B )}^{2} .$$

9. The device (300) according to claim 6,
wherein the channel response values (302) of the pixel are RGB values of the pixel, the RGB values consisting of a red value, R, being the first channel response value of the pixel, a green value, G, being the second channel response value of the pixel, and a blue value, B, being the third channel response value of the pixel, and
wherein the processor is configured to calculate the three or more rational values (303) by respectively using the rational terms of the following set F of rational terms on the RGB values of the pixel:
$${F}_{n} = \{ \frac{{R}^{{α}_{1}} \cdot {G}^{{α}_{2}} \cdot {B}^{{α}_{3}}}{{( R + G + B )}^{{α}_{1} + {α}_{2} + {α}_{3} - 1}} , 1 \leq {α}_{1} + {α}_{2} + {α}_{3} \leq n , n , {α}_{1} , {α}_{2} , {α}_{3} ∈ ℕ \}$$

10. The device (300) according to claim 1, wherein the processor is further configured to:
determine a transformation matrix based on the three or more rational values (303) calculated for each of the pixels; and
transform the image (301) from the source color space into the target color space using the transformation matrix.

11. The device (300) according to claim 10,
wherein the processor is configured to:
generate a channel response vector for each pixel, the channel response vector comprising the channel response values (302) of the pixel and further comprising the three or more rational values (303) calculated for the pixel; and
transform the image (301) from the first color space into the second color space using the channel response vectors calculated for each of the pixels, and
wherein the transformation matrix is determined by performing a Moore-Penrose pseudo-inverse operation based on the generated channel response vectors.

12. The device (300) according to claim 10, wherein the source color space is a device-dependent color space, and the target color space is a device-independent color space.

13. The device (300) according to claim 10, wherein the target color space is defined by XYZ values of the pixels of the image (301), each XYZ value consisting of a first tristimulus value, X, a second tristimulus value, Y, and a third tristimulus value Z of a pixel.

14. The device (300) according to claim 10, wherein the processor is further configured to store the transformed image (301′) or information indicative of the transformed image (301′) in the device (300).

15. The device (300) according to claim 1, wherein the processor is configured to calculate the three or more rational values (303) for each pixel based further on a parameter used to limit the first channel response value, the second channel response value, and/or the third channel response value of the channel response values of the pixel to a minimum value.

16. The device (300) according to claim 1, wherein the processor is configured to calculate the three or more rational values (303) for each pixel based further on one or more weighting parameters used to weigh the first channel response value, the second channel response value, and/or the third channel response value of the channel response values (302) of the pixel.

17. A method (800) for a color-space transformation of an image (301), the method (800) comprising, for each pixel of a plurality of pixels of the image (301):
obtaining (801) channel response values (302) of the pixel, the channel response values (302) comprising a first channel response value, a second channel response value, and a third channel response value of the pixel; and
calculating (802) three or more rational values (303) based on the channel response values (302) of the pixel; and
the method (800) further comprising:
transforming (803) the image (301) from a source color space, which is defined by the channel response values (302) of the pixels of the image, into a target color space using the three or more rational values (303) calculated for each of the pixels.

18. A computer program comprising instructions which, when the program is executed by a processor, cause the processor to perform the method (800) according to claim 17.
